(19) United States
(12) Patent Application Publication
(10) Pub. No.: US 2021/0076640 A1
(43) Pub. Date: Mar. 18, 2021

(54) LIVESTOCK TRAINER

(71) Applicant: Gregory Allen Parker, Tupper Plains, OH (US)

(72) Inventor: Gregory Allen Parker, Tupper Plains, OH (US)

(21) Appl. No.: 17/100,194

(22) Filed: Nov. 20, 2020

Related U.S. Application Data
(63) Continuation of application No. 16/366,716, filed on Mar. 27, 2019.
(60) Provisional application No. 62/652,568, filed on Apr. 4, 2018.

(51) Int. Cl. A01K 15/02

(52) U.S. Cl. CPC A01K 15/027

(57) ABSTRACT

A transportable livestock training apparatus comprises a rotary assembly including a vertical shaft and at least one rotatable radial arm attached to the shaft, the radial arm having a distal end adapted to permit tethering of livestock. The apparatus further comprises a powertrain mechanically connected to the rotary assembly and configured to rotate the radial arm at a predefined speed for a predefined time in a predefined tangential direction and to start and stop upon a command of an operator during a working mode of operation. The apparatus further comprises a frame supporting the rotary assembly and powertrain, the frame including a horizontal base adapted to rest upon a surface and resist slippage and tipping during the working mode. The apparatus further comprises at least two rotatable wheels removably mountable to the frame and adapted to support the livestock training apparatus and roll along the surface in a transport mode.

### CROSS-REFERENCE TO RELATED APPLICATION

This continuation application claims priority to and claims the benefit of U.S. Non-Provisional patent application Ser. No. 16/366,716, entitled “Livestock Trainer”, filed Mar. 27, 2019, which is incorporated by reference in its entirety as if fully set forth herein, claims priority to and claims the benefit of U.S. Provisional Patent Application Ser. No. 62/652,568, entitled “Livestock Trainer,” filed Apr. 4, 2018, which is incorporated by reference in its entirety as if fully set forth herein.

### TECHNICAL FIELD

The apparatuses and methods disclosed in this document pertain generally to the field of livestock domestication. More specifically, the disclosed apparatuses and methods pertain to the training of cattle and other livestock to walk in a prescribed manner.

### BRIEF DESCRIPTION OF THE DRAWINGS

FIG. 1 is a perspective view of a cattle trainer.

FIG. 2 is a table identifying parts for a cattle trainer.

FIG. 3 is a rear elevation of a cattle trainer in working mode.

FIG. 4 is a right elevation of a cattle trainer in transport mode.

FIG. 5 is a bottom view of a cattle trainer.

FIG. 6 is a detail view of a powertrain for a cattle trainer.

### BACKGROUND

A common method for training livestock to obey directions and walk in a prescribed manner on command has long included manual, physical labor by a human trainer. This can be difficult and problematic, particularly for larger animals. For example, show cattle are typically trained to lead after they are weaned. Typically, the show cattle will have already achieved a weight of 400 to 500 pounds after weaning. The training process typically involves attaching a halter to the animal and manually pulling the animal, which can lead to shoulder and other injuries for the human trainer due to the size and strength of the animal. Furthermore, given the significant weight advantage in favor of the animal, the human trainer is forced to engage in a battle of wills. As such, a stubborn animal may require an excessive amount of time to train. The same issues occur in attempting to ensure that livestock is getting sufficient exercise. Therefore, an apparatus and method is needed to more efficiently and safely train or exercise large animals to walk as commanded.

### SUMMARY

Disclosed is a transportable livestock training apparatus, comprising a rotary assembly including a vertical shaft and at least one rotatable radial arm attached to the shaft, the radial arm having a distal end adapted to permit tethering of livestock. Optionally, the apparatus may include multiple radial arms.

Such an apparatus may include a powertrain mechanically connected to the rotary assembly and configured to rotate the radial arms at a predefined speed for a predefined time in a predefined tangential direction and to start and stop upon a command of an operator during a working mode of operation.

Such an apparatus may further include a frame supporting the rotary assembly and powertrain, the frame including a horizontal base and being adapted to rest upon a surface and resist slippage and tipping during the working mode.

Such an apparatus may further include at least one jack adapted to be securely attached to the frame, the jack configured to raise or lower the livestock training apparatus relative to the surface.

Such an apparatus may further include at least two rotatable wheels removably mountable to the frame, the wheels adapted to support the livestock training apparatus and roll along the surface while in a transport mode of operation.

Such an apparatus may further include a mounting apparatus attached to the frame and adapted to mate with a trailer hitch of a vehicle to facilitate movement of the livestock training apparatus during the transport mode.

Such an apparatus may further include removable spikes adapted to secure the horizontal base to the surface.

Such an apparatus may further include a winch mounted on the frame and adapted to facilitate the movement of livestock toward the livestock training apparatus.

In some embodiments, the radial arms may be adjustable in length.

In some embodiments, the horizontal base is octagonal.

In some embodiments, the frame includes at least one support member connecting at least two points of the horizontal base.

In some embodiments, the frame includes a vertical railing attached perpendicularly to the horizontal base and extending around the circumference of the horizontal base.

In some embodiments, the mounting apparatus comprises a tow beam, the tow beam having a proximal end attached to the frame and a distal end further comprising a tongue mount adapted to mate with the tailor hitch.

In some embodiments, the tow beam is detachable from the frame.

In some embodiments, the tow beam is extendable.

In some embodiments, the apparatus further comprises an electronical mast assembly attached to the frame, the mast assembly comprising a rigid conduit orientated perpetual to horizontal base and adapted to facilitate the electrical connection of the livestock training apparatus to a power source.

In some embodiments, the frame includes an H-frame portion adapted to support the powertrain.

In some embodiments, the powertrain comprises a gear box, support housing, and a motor assembly mechanically connected to the rotary assembly.

In some embodiments, the apparatus further comprises a programmable electronic array operable to receive instructions from an operator and engage the powertrain to rotate the rotary assembly at a desired speed, for a desired duration, and in a desired tangential direction.

A method of training livestock using a livestock training apparatus is also disclosed. In one such example, livestock are tethered to a winch attached to a livestock training apparatus. The winch is operated to pull the livestock toward the livestock training apparatus. Alternatively, the livestock may be moved to the livestock training apparatus by manual pulling or any other conventional means.

Further pursuant to this exemplary method, the livestock are tethered to a distal end of one of a plurality of radial arms of the livestock training apparatus and detaching the livestock from the winch.

The above steps of moving livestock to the livestock training apparatus and tethering them to individual radial arms of the plurality of radial arms may be repeated until a desired number of livestock have been tethered to the apparatus.

Further pursuant to this exemplary method, a powertrain of the livestock training apparatus can be engaged to rotate the radial arms at a desired speed, for a desired duration, and in a desired tangential direction.

Also disclosed herein is a method of transporting a livestock training apparatus. An exemplary method includes the steps of removing spikes from a horizontal base of a livestock training apparatus; lifting the livestock training apparatus relative to a surface and attaching rotatable wheels to the frame; mating a mounting apparatus of the livestock training apparatus to a trailer hitch of a vehicle; and driving the vehicle to a desired location.

In some examples of a methods of transporting a livestock training apparatus, the lifting step is includes operating a jack to lift the livestock training apparatus relative to the surface. In some examples, the jack may be attached to the frame. In some examples, the jack may be removable. In other examples, the jacks may be permanently affixed to the frame. In some examples, multiple jacks may be used.

In some examples of a methods of transporting a livestock training apparatus, the mating step may include extending a tow bar attached to the frame at a proximal end of the tow bar and mating a tongue mount located at the distal end of the tow bar with the vehicle trailer hitch.

In some examples of a methods of transporting a livestock training apparatus, extendable radial arms of a rotational assembly of the livestock training apparatus may be retracted during transport.

### DETAILED DESCRIPTION

The apparatuses and methods disclosed and described in this document are described in detail with reference to the views and examples of the included figures. Those of ordinary skill in the art will recognize that modifications to disclosed and described components, elements, methods, materials, and so forth can be made and can be desired for a specific application.

In this disclosure, any identification of specific shapes, materials, techniques, and the like are either related to a specific example presented or are merely a general description of such a shape, material, technique, or the like. Identifications of specific details are not intended to be and should not be construed as mandatory or limiting unless specifically designated as such. Selected examples of plant feeders and methods of use are disclosed and described in detail below. It should be noted that those having an ordinary level of skill in this area will recognize from reading this disclosure that various components of the disclosed apparatuses can be combined in ways not specifically shown in the examples to create an additional specific configuration. For ease of understanding and readability, no attempt is made to catalog every possible combination of the disclosed components.

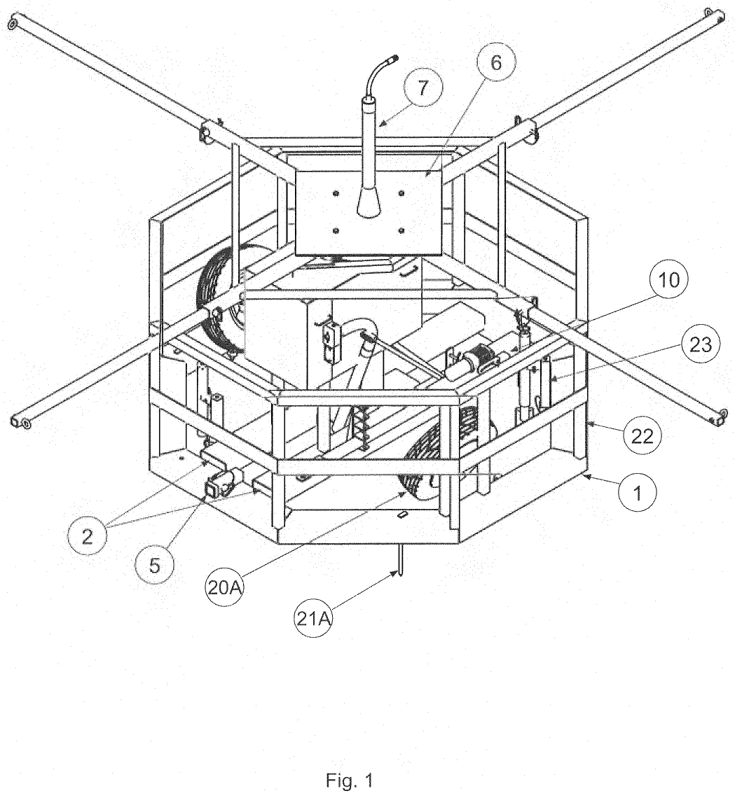

FIG. 1 is a perspective view of one embodiment of a livestock training apparatus 100, including a rotary assembly 6 including a vertical shaft and arms 6A, 6B, 6C, and 6D, extending radially from a central portion of the apparatus. In some examples, the arms may be extendable to different lengths. By tethering the livestock, such as, for example, cattle, to the ends of the radial arms, and powering the movement of the rotary assembly 6, the animal can be made to walk in a circular fashion and at a desired pace. For example, any suitable tethering device such as a strap, rope, cable, or chain can be used to securely connect the radial end of a radial arm to a halter, nose lead, slip lead, or other harness that is securely attached to the livestock.

The rotary assembly 6 and powertrain can be configured to set a desired pace of the livestock as they are walked around the apparatus. Optionally, in some examples, the rotary assembly 6 and powertrain can be configured to reverse direction, causing the livestock to walk in reverse. Optionally, in some examples, the apparatus could be configured to operate for a desired time period, such that the livestock is walked fbr the desired time period. Optionally, in some examples, the apparatus can be configured to start and stop and/or move forward or in reverse at desired intervals to achieve the operator's objectives in training or exercising the livestock.

As further shown in FIG. 1, the apparatus can he constructed with welded steel members, including an octagon base 1, main support members 2, and a protective railing 22.

In operation, the octagon base 1 may rest upon the ground to resist slippage or tipping of the apparatus as may be caused by the forces exerted by the animals being trained. Optionally, removable ground spikes 21A may be inserted through the octagon base 1 and into the ground to further prevent slippage or movement.

To prepare the apparatus for transport mode, the apparatus may be lifted by engaging one or more lifting jacks 23, removing the ground spikes 21A, and mounting the removable wheels 20A. The tongue mount 7 can then be attached to the trailer hitch of a vehicle so the apparatus can be pulled to a desired location.

Optionally, a winch 10 can be incorporated in the apparatus. In some examples, the winch 10 can be capable of pulling a livestock to the apparatus. For example, any suitable tethering device such as a strap, rope, cable, chain, or other tethering device can be securely connected to a halter, nose lead, slip lead, or other harness that is securely attached to the livestock cable, cord, or other tethering device attached to could be attached to a harness attached to the livestock while the livestock is in a pen or other holding area and then pulled, by the winch 10, toward the apparatus, where the livestock could then be attached to the radial arms of the rotary assembly 6.

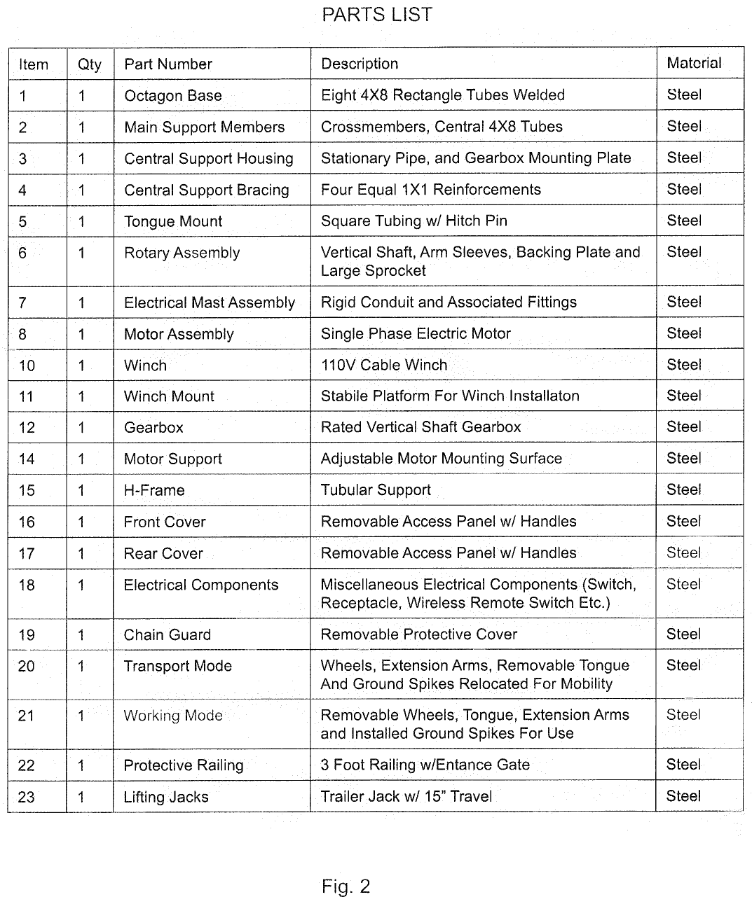

FIG. 2 provides a more complete listing of the various components of the exemplary apparatus depicted in FIG. 1 and FIGS. 3-6.

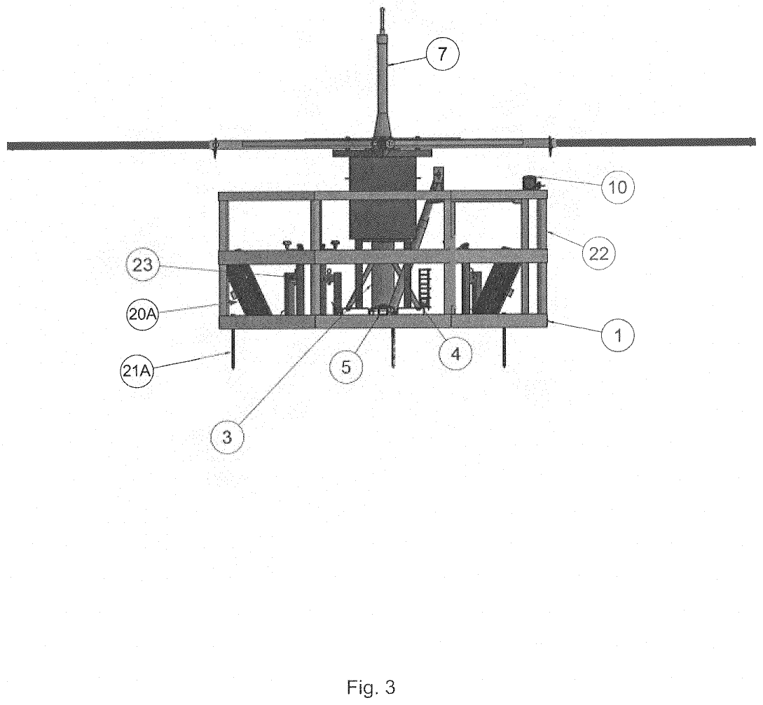

As shown in FIGS. 1 and 3, an electrical mast assembly 7 comprising a rigid conduit and associated fittings may be used to facilitate the electronical connection of the apparatus to a power source by way of a power cable running from the power source to the electrical mast assembly 7.

Also shown in FIG. 3 are a central support housing 3 and central support bracing 4, which provide rigid support for the centrally located members of the apparatus.

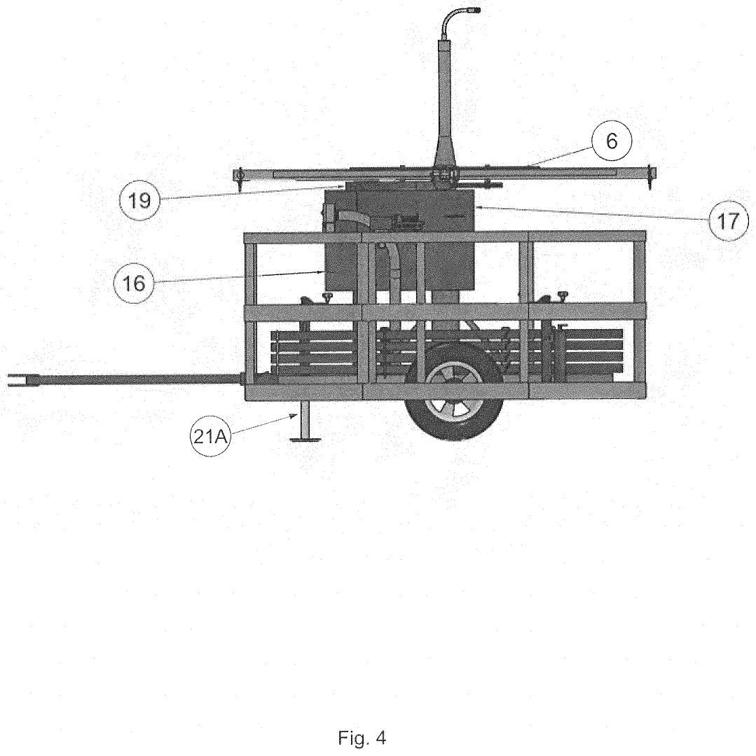

As shown in FIG. 4, centrally located electronic components are housed in an electronical box, having a front cover 16 and rear cover 17, each having removable access panels with handles. A chain guard 19 having a removable protective cover is also shown.

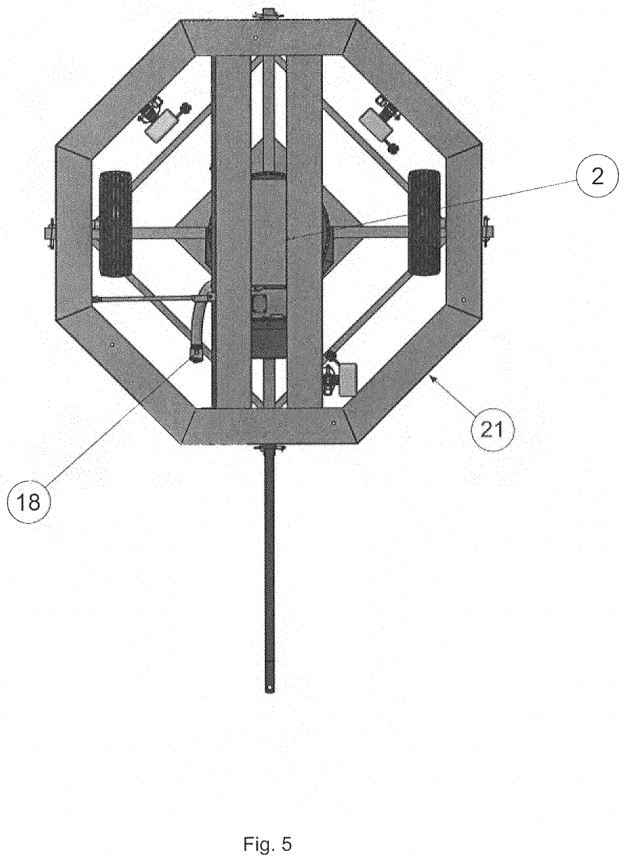

FIG. 5 provides a bottom view of the apparatus, including the main support members 2 and some of the electronic components 18.

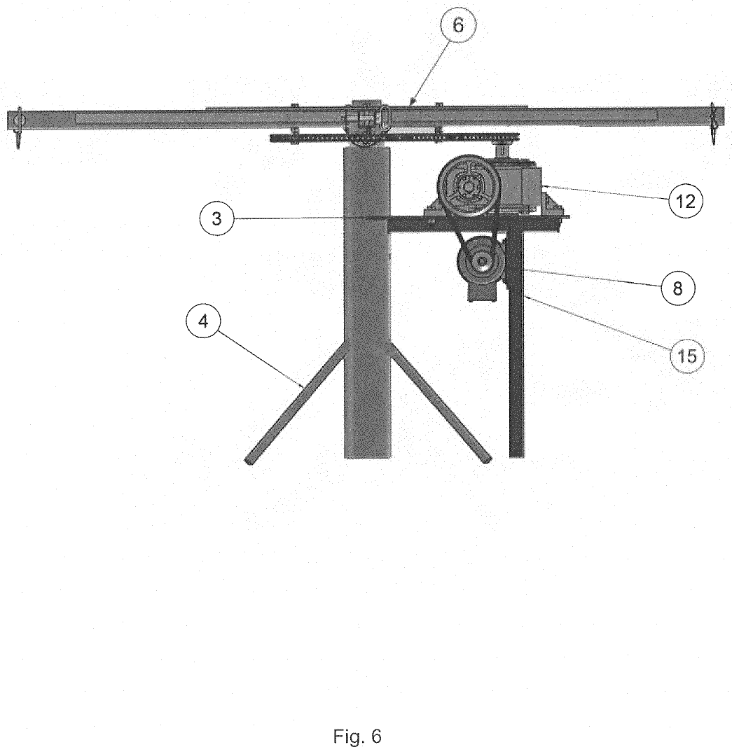

FIG. 6 shows an exemplary powertrain for the apparatus, including a motor assembly 8 connected by a belt and pulley system to a gearbox 12. An H-Frame 15 provides vertical support to the motor assembly. Also shown is a central support housing 3, which includes a stationary pipe, enclosing the vertical shaft of the rotary assembly 6, and a gear box mounting plate, which supports for the gearbox 12 of the motor assembly. As illustrated in FIG. 6, the motor assembly is mechanically connected to the rotary assembly 6.

The apparatus shown can therefore be used to train livestock to walk at a desired pace, for a desired duration, in a desired fashion either forward or backward. The apparatus could be used for a variety of purposes, including training cattle or other livestock for show or simply exercising livestock.

What is claimed is:

1. A transport livestock training apparatus, comprising
a rotary assembly including a vertical shaft and at least one rotatable radial arm attached to the shaft, the radial arm having a distal end adapted to permit tethering of livestock;
a powertrain mechanically connected to the rotary assembly and configured to rotate the radial arm at a predefined speed for a predefined time in a predefined tangential direction and to start and stop upon a command of an operator during a working mode of operation;
a frame supporting the rotary assembly and powertrain, the frame including a horizontal base adapted to rest upon a surface and resist slippage and tipping during the working mode;
at least two rotatable wheels removably mountable to the frame, the wheels adapted to support the livestock training apparatus and roll along the surface while in a transport mode of operation; and
a mounting apparatus attached to the frame and adapted to mate with a trailer hitch of a vehicle to facilitate movement of the livestock training apparatus during the transport mode.

2. The livestock training apparatus of claim 1 further comprising at least one jack adapted to be securely attached to the frame, the jack configured to raise or lower the livestock training apparatus relative to the surface;

3. The livestock training apparatus of claim 2 further comprising removable spikes adapted to secure the horizontal base to the surface.

4. The livestock training apparatus of claim 3 further comprising a winch mounted on the frame and adapted to facilitate the movement of livestock toward the livestock training apparatus.

5. The livestock training apparatus of claim 4 wherein the radial arm is adjustable in length.

6. The livestock training apparatus of claim 5 further comprising at least one additional such radial arm.

7. The livestock training apparatus of claim 6 wherein the horizontal base is octagonal.

7. livestock training apparatus of claim 7 wherein the frame includes at least one support member connecting at least two points of the horizontal base.

9. The livestock training apparatus of claim 8 wherein the frame includes a vertical railing attached perpendicularly to the horizontal base and extending around the circumference of the horizontal base.

10. The livestock training apparatus of claim 9 wherein the mounting apparatus comprises a tow beam, the tow beam having a proximal end attached to the frame and a distal end further comprising a tongue mount adapted to mate with the tailor hitch.

11. The livestock training apparatus of claim 10 wherein the tow beam is detachable from the frame.

12. The livestock training apparatus of claim 11 wherein the tow beam is extendable.

13. The livestock training apparatus of claim 12 further comprising an electronical mast assembly attached to the frame, the mast assembly comprising a rigid conduit orientated perpetual to horizontal base and adapted to facilitate the electrical connection of the livestock training apparatus to a power source.

14. The livestock training apparatus of claim 13 wherein the frame includes an H-frame portion adapted to support the powertrain.

15. The livestock training apparatus of claim 14 wherein the powertrain comprises a gear box, support housing, and a motor assembly mechanically connected to the rotary assembly.

16. The livestock training apparatus of claim 15 further comprising a programmable electronic array operable to receive instructions from an operator and engage the powertrain to rotate the rotary assembly at a desired speed, for a desired duration, and in a desired tangential direction.

17. A method of training livestock comprising
(a) tethering livestock to a winch attached to a livestock training apparatus;
(b) operating the winch to pull the livestock toward the livestock training apparatus;
(c) tethering the livestock to a distal end of one of a plurality of radial arms of the livestock training apparatus and detaching the livestock from the winch;
(d) repeating steps (a) through (c) until a desired number of livestock are each tethered to individual radial arms of the plurality of radial arms; and
(e) operating a powertrain of the livestock training apparatus to rotate the radial arms at a desired speed, for a desired duration, and in a desired tangential direction.

18. A method of transporting a livestock training apparatus, comprising:
(a) removing spikes from a horizontal base of a livestock training apparatus;
(b) lifting the livestock training apparatus relative to a surface and attaching rotatable wheels to the frame;
(c) mating a mounting apparatus of the livestock training apparatus to a trailer hitch of a vehicle; and
(d) driving the vehicle to a desired location.

19. The method of claim 18, wherein step (b) includes operating a jack to lift the livestock training apparatus relative to the surface; attaching first and second rotatable wheels to the frame at first and second wheel attachment locations respectively; and retracting the jack.

20. The method of claim 18 wherein step (c) further comprising the step of extending a tow bar attached to the frame at a proximal end of the tow bar and mating a tongue mount located at the distal end of the tow bar with the vehicle trailer hitch.

21. The method of claim 18 further comprising the step of retracting extendable radial arms of a rotational assembly of the livestock training apparatus.
